(19) United States
(12) Patent Application Publication
(10) Pub. No.: US 2024/0141941 A1
(43) Pub. Date: May 2, 2024

(54) TOILET SEAT RIVET SYSTEMS

(71) Applicant: Vive Health LLC, Naples, FL (US)

(72) Inventors: David Alejandro Villegas, Medellín Antioquia (CO); Juan Carlos Lopez, Naples, FL (US); Daniel John Fleming, Naples, FL (US)

(21) Appl. No.: 17/978,887

(22) Filed: Nov. 1, 2022

(51) Int. Cl. F16B 19/10; A47K 13/26

(52) U.S. Cl. CPC F16B 19/1036; A47K 13/26

(57) ABSTRACT

A rivet system comprises (i) a screw comprising a threaded shaft, (ii) a rigid sleeve comprising a hole extending therethrough for receiving the threaded shaft, (iii) a deformable sleeve comprising a hole extending therethrough; and (iv) a rigid base comprising a threaded hole on a first end of the rigid base, where the first end is configured to insert and advance into the hole of the deformable sleeve to allow the threaded hole of the rigid base to threadedly engage with the threaded shaft of the screw, and where the rigid base comprises an annular channel configured to receive at least part of the deformable sleeve when the first end of the rigid base is inserted and advanced into the hole of the deformable sleeve.

### BACKGROUND

Toilet use is ubiquitous throughout the world. Many toilets include various components, including a toilet bowl, a toilet bowl platform situated about the rim of the toilet bowl, and a toilet seat configured for positioning on and securement to the toilet bowl platform. Toilet seats often include a seat component, a seat cover, and hinge functionality to enable the seat component and the seat cover to be selectively changed between open and closed configurations.

Toilet seats are seldom integrally formed with toilet bowls and are usually selectively connectable to toilet bowl platforms (e.g., after toilet installation). Toilet seats are typically connected to toilet bowl platforms via screw or rivet systems. Selective removability of toilet seats from toilet bowl platforms enables users to replace or upgrade their toilet seats as needed (e.g., responsive to toilet seat breakage, to obtain a toilet seat with improved/additional features such soft close functionality or bidet functionality, and/or to obtain a raised toilet seat to accommodate geriatric or injured users).

Existing screw and/or rivet systems for securing a toilet seat to a toilet bowl platform suffer from a number of challenges. For instance, existing screw and/or rivet systems typically include a limited interface distance between corresponding threaded components (e.g., between a screw/bolt and a corresponding nut). This limited distance results in limited frictional force for securing the toilet seat to the toilet bowl platform, which can cause toilet seat loosening over time through use. Furthermore, the limited distance can give rise to difficulty in achieving a tight configuration.

Toilet seat fastening systems that seek to provide a greater interface distance between threaded components by providing an elongated nut or base component to interface with an elongated screw/bolt often have an unsightly appearance, visibly extending well below the bottom of the toilet bowl platform.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1 illustrates a perspective view of example components of a rivet system.

FIG. 2 illustrates a cross-sectional side view of an example assembled rivet system in a loosened configuration.

FIG. 3 illustrates a cross-sectional side view of an example assembled rivet system in a tightened configuration tightening a toilet seat to a toilet bowl platform.

FIG. 4 illustrates a perspective view of additional example components of a rivet system.

FIG. 5 illustrates a perspective view of an additional example assembled rivet system in a loosened configuration.

### DETAILED DESCRIPTION

Implementations of the present disclosure extend at least to toilet seat rivet systems and components thereof.

In at least some embodiments, a rivet system (e.g., for a toilet seat) includes a screw, a rigid sleeve, a deformable sleeve, and a rigid base. The rigid sleeve and the deformable sleeve each have holes extending therethrough, and the rigid sleeve and the deformable sleeve are configured to interface with one another such that their holes align (e.g., via an external recessed segment of the deformable sleeve interfacing with an internal recessed segment of the rigid sleeve). The screw is configured to insert through the rigid sleeve, and the screw and the rigid sleeve are configured to insert, from the top of a toilet seat, through a hole of the toilet seat and an aligned hole of a toilet bowl platform. The deformable sleeve interfaces with the rigid sleeve from the bottom of the toilet bowl platform, and the screw extends through the hole of the deformable sleeve when aligned with the hole of the rigid sleeve.

The rigid base includes a threaded hole for receiving the screw. The deformable sleeve connects to the rigid base when the screw advances into/through the threaded hole of the rigid base. In some instances, the connection between the deformable sleeve and the rigid base is facilitated by an annular channel on the rigid base that is external to the threaded hole and that receives at least part of the bottom portion of the deformable sleeve. As the screw advances into the threaded hole of the rigid base, the deformable sleeve deforms into contact with the underside of the toilet bowl platform. In some implementations, the rigid base is configured to extend upward through both the hole of the deformable sleeve and the hole of the rigid sleeve during advancement of the screw into the threaded hole of the rigid base.

One or more aspects of the foregoing functionality can facilitate increased frictional force between the screw and the rigid base and/or increased surface contact between the rivet system and the toilet bowl platform and/or toilet seat (e.g., relative to conventional systems), which can contribute to reduced loosening over time and can contributed to ease in achieving a tight configuration (e.g., by providing a greater range of threaded relative positions of the screw and the rigid base for selecting a level of tightness).

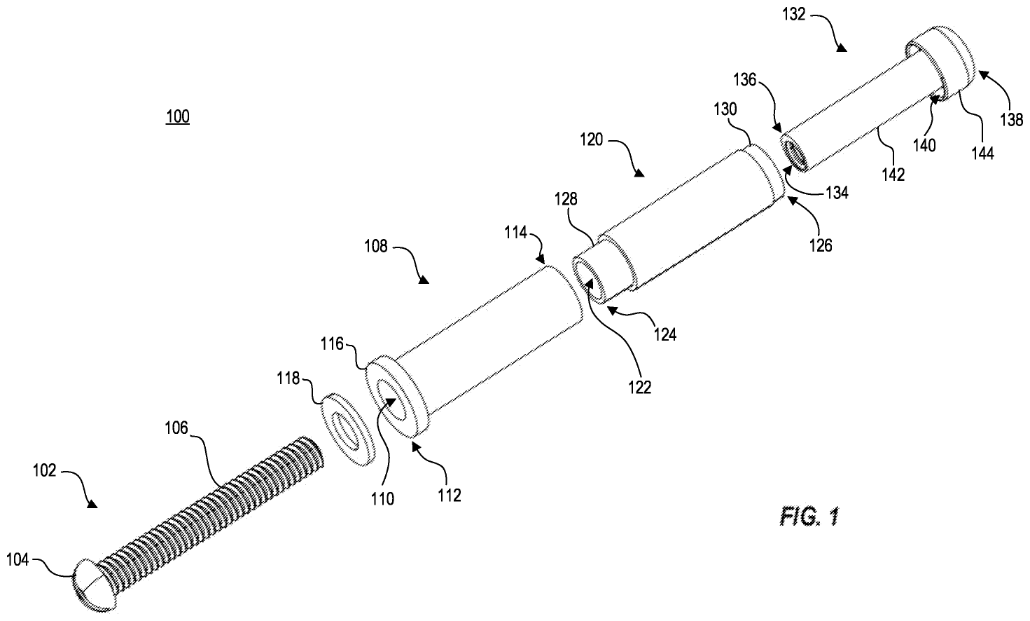

Having described some of the various high-level features and benefits of the disclosed embodiments, attention will now be directed to FIGS. 1 through 5. These Figures illustrate various supporting illustrations related to the disclosed embodiments.

Although the present disclosure focuses, in at least some respects, on examples in which a rivet system is used to secure a toilet seat to a toilet bowl, the rivet systems and/or principles associated therewith may be applied in other contexts and/or use cases.

FIG. 1 illustrates a perspective view of example components of a rivet system 100. In the example of FIG. 1, the rivet system 100 includes a screw 102, which includes a head 104 and a threaded shaft 106. The rivet system 100 of FIG. 1 furthermore includes a rigid sleeve 108, which includes a hole 110 that extend from one end 112 of the rigid sleeve 108 to the other end 114 thereof. The threaded shaft 106 of the screw 102 is configured for insertion through the hole 110 on end 112 of the rigid sleeve 108.

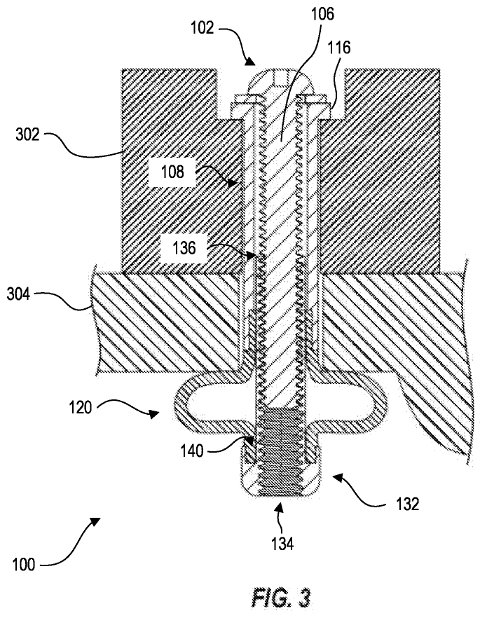

The rigid sleeve 108 of FIG. 1 also includes a collar 116 on end 112, which allows the rigid sleeve 108 to interface with material surrounding a fastener opening of a toilet seat (see FIG. 3). A washer 118 of the rivet system 100 of FIG. 1 is configured to intervene between the head 104 of the screw 102 and the collar 116 of the rigid sleeve 108 when the threaded shaft 106 of the screw 102 is advanced into the hole 110 of the rigid sleeve 108.

The rivet system 100 of FIG. 1 furthermore includes a deformable sleeve 120, which also includes a hole 122 that extends from one end 124 of the deformable sleeve 120 to the other end 126 of the deformable sleeve 120. In the example of FIG. 1, the deformable sleeve 120 includes various interfaces proximate to the ends 124 and 126 thereof to facilitate interfacing between the deformable sleeve 120 and other components of the rivet system 100. For instance, FIG. 1 illustrates the deformable sleeve 120 as including an interface 128 on end 124 and another interface 130 on end 126. Interface 128 of the deformable sleeve 120 is configured to engage with an interface of the rigid sleeve 108, whereas interface 130 of the deformable sleeve 120 is configured to engage with an interface (e.g., an annular channel 140) of the rigid base 132 of the rivet system 100. In the example of FIG. 1, interfaces 128 and 130 are implemented as exterior recessed segments on ends 124 and 126 of the deformable sleeve 120, respectively.

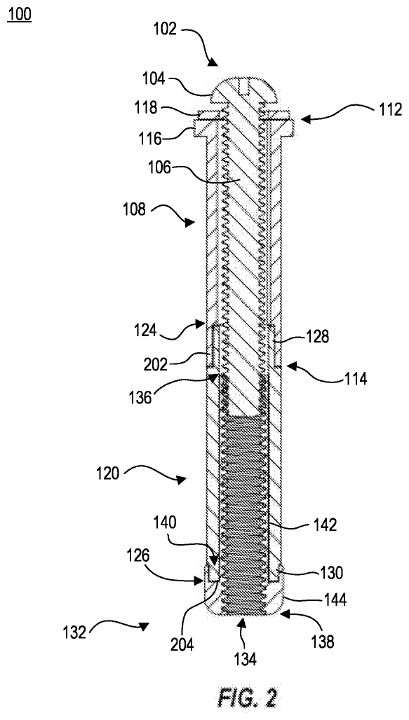

FIG. 2 illustrates a cross-sectional side view of the rivet system 100 in an assembled, loosened configuration. FIG. 2 illustrates an interface 202 on end 114 of the rigid sleeve 108 with which interface 128 of the deformable sleeve 120 is configured to engage. In the example of FIG. 2, interface 202 of the rigid sleeve is implemented as an interior recessed segment on end 114 of the rigid sleeve 108.

One will appreciate, in view of the present disclosure, that the particular forms of the interfaces 128, 130 and 202 (as well as other interfaces described herein, such as the annular channel 140 the rigid base 132) in the examples provided herein are provided by way of conceptual illustration only and are not limiting of the present disclosure. For example, interface 202 may be implemented as an annular channel, or interfaces 128 and/or 130 may be implemented as non-recessed segments of the deformable sleeve 120, etc.

Referring again to FIG. 1, the illustrated rivet system 100 includes a rigid base 132. The rigid base 132 of FIG. 1 comprises a threaded hole 134 on end 136 of the rigid base 132. In some instances, as in the example of FIGS. 1-3, the threaded hole 134 extends through the rigid base 132 to end 138 of the rigid base 132. In some implementations, however, the threaded hole 134 does not fully span the longitudinal axis of the rigid base 132.

As illustrated in the example of FIG. 1, the rigid base 132 includes an annular channel 140, which may be positioned proximate to end 138 of the rigid base 132. The annular channel 140 of the rigid base 132 is defined by part of a first outer wall 142 of the rigid base (e.g., which, in some instances, extends outside of a portion of the threaded hole 134) and a second outer wall 144 that is offset outward from the first outer wall 142. In the example of FIG. 1, the annular channel 140 is formed by an outer portion of the first outer wall 142 and an inner portion of the second outer wall 144. FIG. 2 illustrates that the example annular channel 140 is furthermore formed by a channel base 204 that extends from the first outer wall to the second outer wall 144.

The assembled configuration of FIG. 2 illustrates that end 136 of the rigid base 132 is sized and configured for insertion into and advancement into hole 122 (not labeled in FIG. 2) on end 126 of the deformable sleeve 120. With the threaded shaft 106 of the screw 102 inserted through hole 110 (not labeled in FIG. 2) on end 112 of the rigid sleeve 108 and inserted into hole 122 on end 124 of the deformable sleeve 120, threaded hole 134 of the rigid base 132 may reach the threaded shaft 106 via insertion of end 136 of the rigid base 132 into hole 122 on end 126 of the deformable sleeve 120. The threaded shaft 106 may then threadedly engage with the threaded hole 134.

As the end 136 of the rigid base 132 advances through the deformable sleeve 120 and/or into engagement with the threaded shaft 106, the annular channel 140 receives end 126 of the deformable sleeve 120. In the example of FIG. 2, the annular channel 140 of the rigid base 132 receives interface 130 of the deformable sleeve 120 (e.g., the exterior recessed segment on end 126 of the deformable sleeve 120).

With a configuration similar to that shown in FIG. 2 achieved (e.g., with the threaded shaft 106 inserted through the rigid sleeve 108 and into the deformable sleeve 120 to engage with the threaded hole 134 of the rigid base 132 as end 136 of the rigid base 132 is inserted into the deformable sleeve 120), the threaded shaft 106 may continue to thread into further engagement with the threaded hole 134 of the rigid base 132, thereby causing deformation of the deformable sleeve 120 by drawing the rigid base 132 (e.g., which is engaged with the deformable sleeve 120 via the annular channel 140 of the rigid base 132) toward (and/or into) the rigid sleeve 108 (e.g., which is engaged with the deformable sleeve via the interface 202).

For example, FIG. 3 illustrates a cross-sectional side view of the example rivet system 100 in a tightened configuration, tightening a toilet seat 302 to a toilet bowl platform 304 (some labels of components of the rivet system 100 are omitted from FIG. 3 to improve clarity). FIG. 3 illustrates the rigid sleeve 108 inserted through an opening of a toilet seat 302 and through an opening of a toilet bowl platform 304 (from the top of the toilet seat). FIG. 3 illustrates the collar 116 of the rigid sleeve 108 contacting material surrounding the opening on the top of the toilet seat 302 to allow the rivet system 100 to secure the toilet seat 302 to the toilet bowl platform 304 as the rivet system 100 tightens.

FIG. 3 also illustrates the deformable sleeve 120 interfacing with the rigid sleeve 108 from the bottom of the toilet bowl platform 304 (e.g., via the interfaces 128 and 202 of the rigid sleeve 108 and the deformable sleeve 120, respectively) while the rigid sleeve 108 is inserted through the opening of the toilet seat 302 and the toilet bowl platform 304. FIG. 3 furthermore illustrates the threaded shaft 106 of the screw 102 inserted through the rigid sleeve 108 and into the deformable sleeve 120 to engage with the threaded hole 134 of the rigid base 132 while end 136 of the rigid base 132 is inserted into (and/or through) the deformable sleeve 120 from the bottom of the toilet bowl platform 304.

FIG. 3 shows the rigid base 132 in engagement with the deformable sleeve 120 via the annular channel 140 of the rigid base 132. As the screw 102 threads into engagement with the threaded hole 134 of the rigid base 132, the rigid base 132 is drawn toward the rigid sleeve 108 (which is also engaged with the deformable sleeve 120). In the example of FIG. 3, drawing the rigid base 132 toward the rigid sleeve 108 (with both the rigid base 132 and the rigid sleeve 108 engaged with opposing ends and/or interfaces of the deformable sleeve 120) causes deformation of the deformable sleeve 120, allowing the deformable sleeve 120 to contact one or more bottom portions of the toilet bowl platform 304 (e.g., proximate to the bottom portion of the hole of the toilet bowl platform 304 through which components of the rivet system 100 are inserted).

With the deformable sleeve 120 securing to the bottom portion of the toilet bowl platform 304, continued threading of the screw 102 into engagement with the rigid base 132 can cause the deformable sleeve 120 and the collar 116 of the rigid sleeve 108 to tighten about the toilet seat 302 and the toilet bowl platform 304 from opposing sides, thereby securing the toilet seat 302 to the toilet bowl platform 304 in a stable manner.

FIG. 3 furthermore illustrates that, in some instances, end 136 of the rigid base 132 can at least partially extend into hole 110 of the rigid sleeve 108 during advancement of the screw 102 into threaded engagement with the rigid base 132 (e.g., and while the deformable sleeve 120 interfaces with the rigid sleeve 108 and while the deformable sleeve 120 is received by the annular channel 140 of the rigid base 132).

At least some of the foregoing functionality can facilitate increased frictional force between the screw 102 and the rigid base 132 and/or increased surface contact between the rivet system 100 and the toilet bowl platform 304 and/or toilet seat 302 (e.g., relative to conventional systems), which can contribute to a stable connection/fastening of the toilet seat 302 to the toilet bowl platform 304, reduced loosening over time, and/or can ease in achieving a tight configuration (e.g., by providing a greater range of threaded relative positions of the screw and the rigid base for selecting a level of tightness).

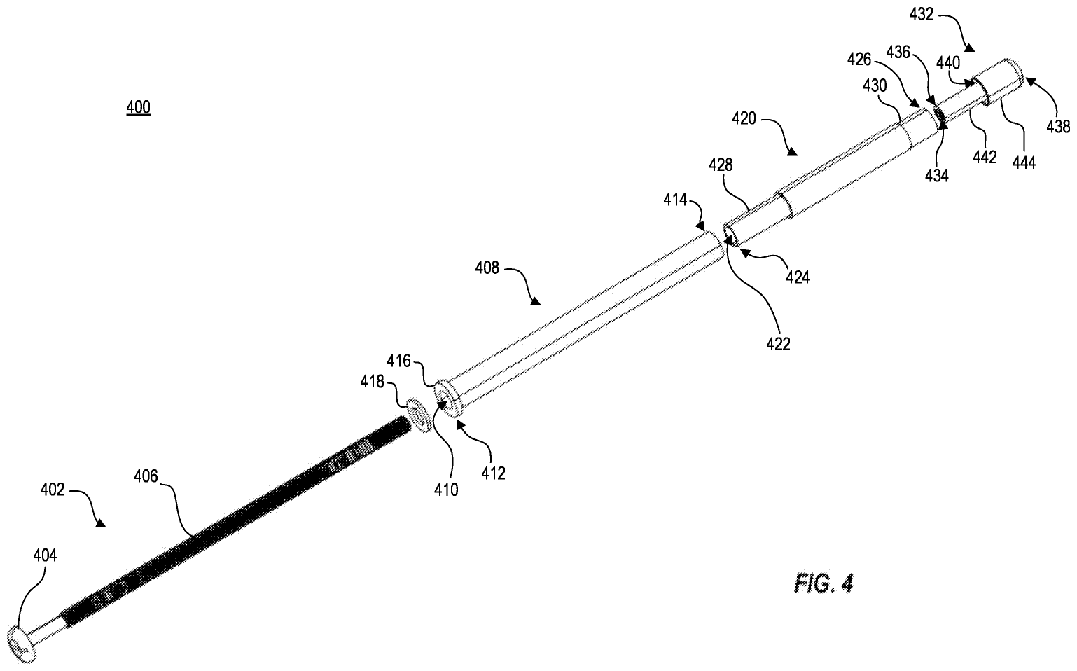

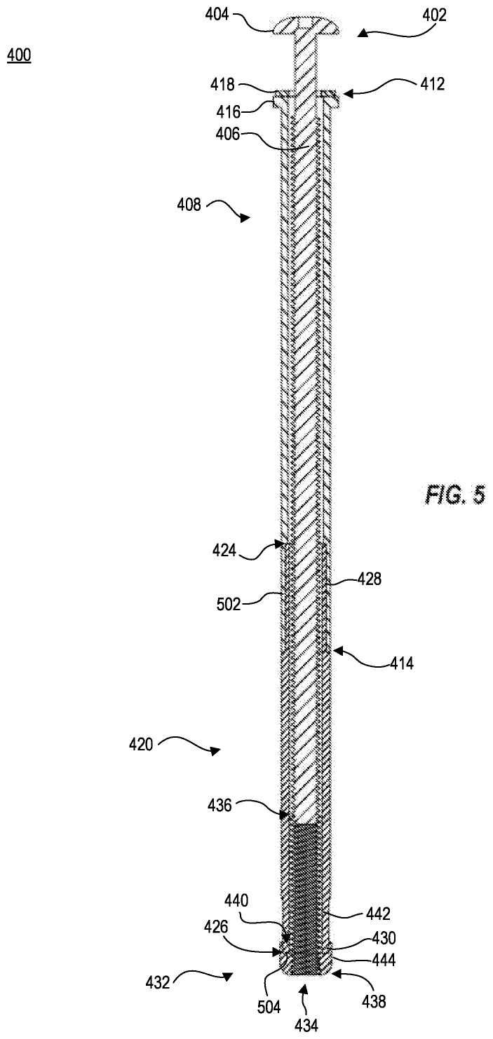

One will appreciate, in view of the present disclosure, that at least some of the particular sizes, shapes, and/or other aspects of components of the rivet system 100 shown hereinabove are provided by way of illustrative example only and are not limiting of the present disclosure. For instance, FIG. 4 illustrates a perspective view of additional example of components of a rivet system 400 (e.g., designed for a raised toilet seat), which includes components similar to the rivet system 100 described hereinabove with reference to FIGS. 1 through 3. FIG. 5 illustrates a side cross-sectional view of components of the rivet system 400 in an assembled, loosened configuration.

For instance, rivet system 400 includes a screw 402 (e.g., with a head 404 and a threaded shaft 406), a washer 418, a rigid sleeve 408 (e.g., with a collar 416, with an interface 502, and with an opening 410 extending from end 412 to end 414), a deformable sleeve 420 (e.g., with an opening 422 extending from end 424 to end 426 and with interfaces 428 and 430 arranged at ends 424 and 426, respectively), a rigid base 432 (e.g., with an opening 434 from end 436 to end 438, with an annular channel 440 defined by outer walls 442 and 444 and by a channel base 504), etc.

It will be appreciated that systems, devices, products, kits, methods, and/or processes, according to certain embodiments of the present disclosure may include, incorporate, or otherwise comprise properties, features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

This disclosure provides various examples, embodiments, and features which, unless expressly stated or which would be mutually exclusive, should be understood to be combinable with other examples, embodiments, or features described herein.

In addition to the above, further embodiments and examples include the following:
1. A rivet system, comprising: a screw comprising a head and a threaded shaft; a rigid sleeve comprising a hole extending from a first end to a second end of the rigid sleeve, the threaded shaft of the screw being configured to insert through the hole on the first end of the rigid sleeve, the rigid sleeve comprising an interface on the second end of the rigid sleeve; a deformable sleeve comprising a hole extending from a first end to a second end of the deformable sleeve, the deformable sleeve comprising a corresponding interface on the first end of the deformable sleeve, the deformable sleeve and the rigid sleeve being configured to interface with one another via the interface of the rigid sleeve and the corresponding interface of the deformable sleeve; and a rigid base comprising a threaded hole on a first end of the rigid base, the first end of the rigid base being configured to insert and advance into the hole on the second end of the deformable sleeve, the threaded hole of the rigid base being configured to threadedly engage with the threaded shaft of the screw when the first end of the rigid base is inserted and advanced into the hole on the second end of the deformable sleeve, the rigid base comprising an annular channel configured to receive at least part of the second end of the deformable sleeve when the first end of the rigid base is inserted and advanced into the hole on the second end of the deformable sleeve.
2. The rivet system of 1, further comprising a washer configured to intervene between the head of the screw and the first end of the rigid sleeve.
3. The rivet system of any one or a combination of 1 and/or 2, wherein the rigid sleeve is configured to insert through an opening of a toilet seat and through an opening of a toilet bowl platform from a top of the toilet seat.
4. The rivet system of 3, wherein the rigid sleeve comprises a collar on the first end of the rigid sleeve, wherein the collar is configured to interface with material surrounding the opening of the toilet seat.
5. The rivet system of any one or a combination of 3 and/or 4, wherein the deformable sleeve is configured to interface with the rigid sleeve from a bottom of the toilet bowl platform when the rigid sleeve is inserted through the opening of the toilet seat and through the opening of the toilet bowl platform from the top of the toilet seat.
6. The rivet system of 5, wherein the threaded hole of the rigid base is configured to receive the threaded shaft of the screw from the bottom of the toilet bowl platform when the threaded shaft is inserted through the rigid sleeve while the rigid sleeve is inserted through the opening of the toilet seat and through the opening of a toilet bowl platform from the top of the toilet seat.
7. The rivet system of any one or a combination of 1 through 6, wherein the annular channel of the rigid base is defined by (i) a section of a first outer wall of the rigid base that extends outside of a portion of the threaded hole of the rigid base and (ii) a second outer wall that is offset outward from the first outer wall.
8. The rivet system of 7, wherein the annular channel of the rigid base is further defined by a channel base that extends from the first outer wall to the second outer wall of the rigid base.
9. The rivet system of any one or a combination of 1 through 8, wherein the corresponding interface of the deformable sleeve comprises an exterior recessed segment on the first end of the deformable sleeve, and wherein the interface of the rigid sleeve comprises an interior recessed segment on the second end of the rigid sleeve.
10. The rivet system of any one or a combination of 1 through 9, wherein at least the part of the second end of the deformable sleeve that is received by the annular channel of the rigid base comprises a second interface on the second end of the deformable sleeve.
11. The rivet system of 10, wherein the second interface comprises an exterior recessed segment on the second end of the deformable sleeve.
12. The rivet system of any one or a combination of 1 through 11, wherein the first end of the rigid base is configured to extend into the hole on the second end of the rigid sleeve when the threaded shaft of the screw is advanced into the threaded hole of the rigid base while the threaded shaft of the screw is inserted through the hole of the first end of the rigid sleeve and when the first end of the deformable sleeve interfaces with the second end of the rigid sleeve and when at least the part of the second end of the deformable sleeve is received by the annular channel of the rigid base.
13. A rivet system, comprising: a screw comprising a head and a threaded shaft; a rigid sleeve comprising a hole extending from a first end to a second end of the rigid sleeve, the threaded shaft of the screw being configured to insert through the hole on the first end of the rigid sleeve, the rigid sleeve comprising an interior recessed segment on the second end of the rigid sleeve; a deformable sleeve comprising a hole extending from a first end to a second end of the deformable sleeve, the deformable sleeve comprising an exterior recessed segment on the first end of the deformable sleeve, the deformable sleeve and the rigid sleeve being configured to connect with one another via the interior recessed segment of the rigid sleeve and the exterior recessed segment of the deformable sleeve; and a rigid base comprising a threaded hole on a first end of the rigid base, the first end of the rigid base being configured to insert and advance into the hole on the second end of the deformable sleeve, the threaded hole of the rigid base being configured to threadedly engage with the threaded shaft of the screw when the first end of the rigid base is inserted and advanced into the hole on the second end of the deformable sleeve.
14. The rivet system of 13, wherein the deformable sleeve further comprises a second exterior recessed segment on the second end of the deformable sleeve.
15. The rivet system of 14, wherein the rigid base further comprises an annular channel configured to receive the second exterior recessed segment of the deformable sleeve when the first end of the rigid base is inserted and advanced into the hole on the second end of the deformable sleeve.
16. The rivet system of any one or a combination of 13 through 15, wherein the first end of the rigid base is configured to extend into the hole on the second end of the rigid sleeve when the threaded shaft of the screw is advanced into the threaded hole of the rigid base while the threaded shaft of the screw is inserted through the hole of the first end of the rigid sleeve and when the first end of the deformable sleeve connects with the second end of the rigid sleeve.
17. A rivet system, comprising: a screw comprising a head and a threaded shaft; a rigid sleeve comprising a hole extending from a first end to a second end of the rigid sleeve, the threaded shaft of the screw being configured to insert through the hole on the first end of the rigid sleeve, the rigid sleeve comprising an interface on the second end of the rigid sleeve; a deformable sleeve comprising a hole extending from a first end to a second end of the deformable sleeve, the deformable sleeve comprising a corresponding interface on the first end of the deformable sleeve, the deformable sleeve and the rigid sleeve being configured to interface with one another via the interface of the rigid sleeve and the corresponding interface of the deformable sleeve; and a rigid base comprising a threaded hole on a first end of the rigid base, the first end of the rigid base being configured to insert and advance into the hole on the second end of the deformable sleeve, the threaded hole of the rigid base being configured to threadedly engage with the threaded shaft of the screw when the first end of the rigid base is inserted and advanced into the hole on the second end of the deformable sleeve, wherein the first end of the rigid base is configured to extend into the hole on the second end of the rigid sleeve when the threaded shaft of the screw is advanced into the threaded hole of the rigid base while the threaded shaft of the screw is inserted through the hole of the first end of the rigid sleeve and when the first end of the deformable sleeve interfaces with the second end of the rigid sleeve.
18. The rivet system of 17, wherein the deformable sleeve further comprises a second interface on the second end of the deformable sleeve.
19. The rivet system of 18, wherein the rigid base further comprises an annular channel configured to receive the second interface of the deformable sleeve when the first end of the rigid base is inserted and advanced into the hole on the second end of the deformable sleeve.
20. The rivet system of any one or a combination of 17 through 19, wherein the corresponding interface of the deformable sleeve comprises an exterior recessed segment on the first end of the deformable sleeve, and wherein the interface of the rigid sleeve comprises an interior recessed segment on the second end of the rigid sleeve.

What is claimed is:

1. A rivet system, comprising:
a screw comprising a head and a threaded shaft;
a rigid sleeve comprising a hole extending from a first end to a second end of the rigid sleeve, the threaded shaft of the screw being configured to insert through the hole on the first end of the rigid sleeve, the rigid sleeve comprising an interface on the second end of the rigid sleeve;
a deformable sleeve comprising a hole extending from a first end to a second end of the deformable sleeve, the deformable sleeve comprising a corresponding interface on the first end of the deformable sleeve, the deformable sleeve and the rigid sleeve being configured to interface with one another via the interface of the rigid sleeve and the corresponding interface of the deformable sleeve; and
a rigid base comprising a threaded hole on a first end of the rigid base, the first end of the rigid base being configured to insert and advance into the hole on the second end of the deformable sleeve, the threaded hole of the rigid base being configured to threadedly engage with the threaded shaft of the screw when the first end of the rigid base is inserted and advanced into the hole on the second end of the deformable sleeve, the rigid base comprising an annular channel configured to receive at least part of the second end of the deformable sleeve when the first end of the rigid base is inserted and advanced into the hole on the second end of the deformable sleeve.

2. The rivet system of claim 1, further comprising a washer configured to intervene between the head of the screw and the first end of the rigid sleeve.

3. The rivet system of claim 1, wherein the rigid sleeve is configured to insert through an opening of a toilet seat and through an opening of a toilet bowl platform from a top of the toilet seat.

4. The rivet system of claim 3, wherein the rigid sleeve comprises a collar on the first end of the rigid sleeve, wherein the collar is configured to interface with material surrounding the opening of the toilet seat.

5. The rivet system of claim 3, wherein the deformable sleeve is configured to interface with the rigid sleeve from a bottom of the toilet bowl platform when the rigid sleeve is inserted through the opening of the toilet seat and through the opening of the toilet bowl platform from the top of the toilet seat.

6. The rivet system of claim 5, wherein the threaded hole of the rigid base is configured to receive the threaded shaft of the screw from the bottom of the toilet bowl platform when the threaded shaft is inserted through the rigid sleeve while the rigid sleeve is inserted through the opening of the toilet seat and through the opening of a toilet bowl platform from the top of the toilet seat.

7. The rivet system of claim 1, wherein the annular channel of the rigid base is defined by (i) a section of a first outer wall of the rigid base that extends outside of a portion of the threaded hole of the rigid base and (ii) a second outer wall that is offset outward from the first outer wall.

8. The rivet system of claim 7, wherein the annular channel of the rigid base is further defined by a channel base that extends from the first outer wall to the second outer wall of the rigid base.

9. The rivet system of claim 1, wherein the corresponding interface of the deformable sleeve comprises an exterior recessed segment on the first end of the deformable sleeve, and wherein the interface of the rigid sleeve comprises an interior recessed segment on the second end of the rigid sleeve.

10. The rivet system of claim 1, wherein at least the part of the second end of the deformable sleeve that is received by the annular channel of the rigid base comprises a second interface on the second end of the deformable sleeve.

11. The rivet system of claim 10, wherein the second interface comprises an exterior recessed segment on the second end of the deformable sleeve.

12. The rivet system of claim 1, wherein the first end of the rigid base is configured to extend into the hole on the second end of the rigid sleeve when the threaded shaft of the screw is advanced into the threaded hole of the rigid base while the threaded shaft of the screw is inserted through the hole of the first end of the rigid sleeve and when the first end of the deformable sleeve interfaces with the second end of the rigid sleeve and when at least the part of the second end of the deformable sleeve is received by the annular channel of the rigid base.

13. A rivet system, comprising:
a screw comprising a head and a threaded shaft;
a rigid sleeve comprising a hole extending from a first end to a second end of the rigid sleeve, the threaded shaft of the screw being configured to insert through the hole on the first end of the rigid sleeve, the rigid sleeve comprising an interior recessed segment on the second end of the rigid sleeve;
a deformable sleeve comprising a hole extending from a first end to a second end of the deformable sleeve, the deformable sleeve comprising an exterior recessed segment on the first end of the deformable sleeve, the deformable sleeve and the rigid sleeve being configured to connect with one another via the interior recessed segment of the rigid sleeve and the exterior recessed segment of the deformable sleeve; and
a rigid base comprising a threaded hole on a first end of the rigid base, the first end of the rigid base being configured to insert and advance into the hole on the second end of the deformable sleeve, the threaded hole of the rigid base being configured to threadedly engage with the threaded shaft of the screw when the first end of the rigid base is inserted and advanced into the hole on the second end of the deformable sleeve.

14. The rivet system of claim 13, wherein the deformable sleeve further comprises a second exterior recessed segment on the second end of the deformable sleeve.

15. The rivet system of claim 14, wherein the rigid base further comprises an annular channel configured to receive the second exterior recessed segment of the deformable sleeve when the first end of the rigid base is inserted and advanced into the hole on the second end of the deformable sleeve.

16. The rivet system of claim 13, wherein the first end of the rigid base is configured to extend into the hole on the second end of the rigid sleeve when the threaded shaft of the screw is advanced into the threaded hole of the rigid base while the threaded shaft of the screw is inserted through the hole of the first end of the rigid sleeve and when the first end of the deformable sleeve connects with the second end of the rigid sleeve.

17. A rivet system, comprising:
a screw comprising a head and a threaded shaft;
a rigid sleeve comprising a hole extending from a first end to a second end of the rigid sleeve, the threaded shaft of the screw being configured to insert through the hole on the first end of the rigid sleeve, the rigid sleeve comprising an interface on the second end of the rigid sleeve;
a deformable sleeve comprising a hole extending from a first end to a second end of the deformable sleeve, the deformable sleeve comprising a corresponding interface on the first end of the deformable sleeve, the deformable sleeve and the rigid sleeve being configured to interface with one another via the interface of the rigid sleeve and the corresponding interface of the deformable sleeve; and
a rigid base comprising a threaded hole on a first end of the rigid base, the first end of the rigid base being configured to insert and advance into the hole on the second end of the deformable sleeve, the threaded hole of the rigid base being configured to threadedly engage with the threaded shaft of the screw when the first end of the rigid base is inserted and advanced into the hole on the second end of the deformable sleeve, wherein the first end of the rigid base is configured to extend into the hole on the second end of the rigid sleeve when the threaded shaft of the screw is advanced into the threaded hole of the rigid base while the threaded shaft of the screw is inserted through the hole of the first end of the rigid sleeve and when the first end of the deformable sleeve interfaces with the second end of the rigid sleeve.

18. The rivet system of claim 17, wherein the deformable sleeve further comprises a second interface on the second end of the deformable sleeve.

19. The rivet system of claim 18, wherein the rigid base further comprises an annular channel configured to receive the second interface of the deformable sleeve when the first end of the rigid base is inserted and advanced into the hole on the second end of the deformable sleeve.

20. The rivet system of claim 17, wherein the corresponding interface of the deformable sleeve comprises an exterior recessed segment on the first end of the deformable sleeve, and wherein the interface of the rigid sleeve comprises an interior recessed segment on the second end of the rigid sleeve.
